(19) United States
(12) Patent Application Publication
(10) Pub. No.: US 2026/0276976 A1
(43) Pub. Date: Sep. 17, 2026

(54) LENS UNIT, CAMERA MODULE, IMAGING SYSTEM, AND MOBILE BODY

(71) Applicants: Maxell, Ltd., Kyoto (JP); Murata Manufacturing Co., Ltd., Nagaokakyo-shi, Kyoto (JP)

(72) Inventors: Yusuke BABA, Kyoto (JP); Yuka TANAKA, Nagaokakyo-shi, Kyoto (JP); Hitoshi SAKAGUCHI, Nagaokakyo-shi, Kyoto (JP); Yuki ISHII, Nagaokakyo-shi, Kyoto (JP)

(73) Assignees: Maxell, Ltd., Kyoto (JP); Murata Manufacturing Co., Ltd., Nagaokakyo-shi, Kyoto (JP)

(21) Appl. No.: 19/167,857

(22) PCT Filed: Mar. 21, 2024
(86) PCT No.: PCT/JP2024/011153

§ 371 Date: Sep. 23, 2025

(30) Foreign Application Priority Data
Mar. 28, 2023 (JP) 2023-051706

(51) Int. Cl. G02B 27/00; G02B 7/02

(52) U.S. Cl. CPC G02B 27/0006; G02B 7/021

(57) ABSTRACT

Provided are a lens unit, a camera module, an imaging system, and a mobile body in which vibration is easily transmitted from a vibrating body to a first lens.

A lens group in which a plurality of lenses is arranged along an optical axis of the lenses and a lens barrel that houses and holds the lens group are provided, a vibration mechanism including a vibrating body that vibrates a first lens located closest to an object side among the plurality of lenses is provided, a black adhesive layer is provided on a flat surface of the first lens facing an image side, and the vibrating body is bonded to the flat surface via the black adhesive layer.

### TECHNICAL FIELD

The present invention relates to a lens unit constituting an in-vehicle camera mounted on a vehicle such as an automobile, a camera module, an imaging system, and a mobile body on which the imaging system is mounted.

### BACKGROUND ART

Conventionally, an in-vehicle camera is mounted on an automobile to support parking and prevent collision by image recognition, and further, attempts have been made to apply this to automatic driving. Further, such a camera module of an in-vehicle camera or the like generally includes a lens unit including a lens group formed by arranging a plurality of lenses along an optical axis, a lens barrel (barrel) that houses and holds the lens group, and a diaphragm member disposed between lenses of at least one part of the lens group (see, for example, Patent Literature 1).

FIG. 8 illustrates an example of a conventional lens unit 100. As illustrated in the drawing, the lens unit 100 includes a cylindrical lens barrel 120 and a plurality of lenses 130, 140, 150, 160, and 170 arranged in an inner accommodating space of the lens barrel 120. These lenses 130, 140, 150, 160, and 170 fixed to and supported by the lens barrel 120 are arranged in a state where their respective optical axes coincide with each other, and are arranged along one optical axis O to constitute one lens group L used for imaging by a package sensor (image sensor; not illustrated) on an image side.

Note that, in FIG. 8, hatching is omitted for lenses 130, 140, 150, 160, and 170.

In addition, in a form in which such lenses 130, 140, 150, 160, and 170 are incorporated in the inner accommodating space of the lens barrel 120 so as to be stacked in order from the image side toward the object side, adjacent lenses often come into surface contact so as to abut against each other at their seat surfaces. Then, in such a case, particularly with respect to the first and second lenses 130 and 140 adjacent to each other, when the first lens 130 is made of glass and the second lens 140 is made of resin, it is common that ink 210 is applied to a flat surface on the image side of the first lens 130 in contact with the seat surface of a flange of the second lens 140 for the purpose of preventing transmission and reflection of stray light.

### CITATION LIST

### Patent Literature

Patent Literature 1: JP 2013-231993 A

### SUMMARY OF INVENTION

### Technical Problem

Incidentally, when foreign matter such as water droplets, muddy water, ice and snow, and frost adhering to a lens surface of the first lens is to be removed by vibrating (ultrasonic vibration) the first lens by a vibrating body, the flat surface on the image side of the first lens and the vibrating body are bonded with an adhesive in order to transmit vibration from the vibrating body to the first lens. Since the ink is applied to the flat surface of the first lens as described above, two layers of an ink layer formed by the ink and an adhesive layer formed by the adhesive are interposed between the flat surface of the first lens and the vibrating body.

Since the ink layer and the adhesive layer have substantially the same thickness (for example, 5 to 20 μm), the layer thickness between the flat surface of the first lens and the vibrating body is about twice as large as the case where the vibrating body is not provided. When the layer thickness is doubled, both the ink layer and the adhesive layer absorb the vibration, and there is a problem that the vibration is not easily transmitted from the vibrating body to the first lens.

The present invention has been made in view of the above circumstances, and an object thereof is to provide a lens unit, a camera module, an imaging system, and a mobile body in which vibration is easily transmitted from a vibrating body to a first lens.

### Solution to Problem

In a lens unit including a lens group in which a plurality of lenses is arranged along an optical axis of the lenses, and a lens barrel that houses and holds the lens group,
the lens unit includes a vibration mechanism including a vibrating body that vibrates a first lens located closest to an object side among the plurality of lenses,
a black adhesive layer is provided on a flat surface of the first lens facing an image side, and
the vibrating body is bonded to the flat surface via the black adhesive layer.

Unlike the related art, the ink is not applied to the flat surface facing the image side of the first lens and to which the vibrating body is bonded, and instead, a black adhesive layer is provided.

Examples of the black adhesive that forms the black adhesive layer include epoxy-based adhesives.

The Young's modulus of the black adhesive layer is preferably 2 to 5 GPa, and the layer thickness of the black adhesive layer is preferably 5 to 20 μm.

In the present invention, since the black adhesive layer is provided on the flat surface facing the image side of the first lens, and the vibrating body is bonded to the flat surface via the black adhesive layer, the ink layer is not interposed between the vibrating body and the flat surface of the first lens, and only the black adhesive layer is interposed, so that vibration is easily transmitted from the vibrating body to the first lens.

Further, by vibrating the first lens by the vibrating body of the vibration mechanism, foreign matter such as water droplets, muddy water, ice and snow, and frost adhering to the lens surface of the first lens can be removed.

Here, in a case where the layer thickness of the black adhesive layer formed by the black adhesive is about 5 to 20 μm, the black adhesive layer cannot sufficiently shield light and transmits the light, and there is a possibility that ghost flare cannot be reduced. Therefore, by mixing a black filler with the black adhesive, the black adhesive layer also becomes uniform and thickness unevenness is less likely to occur because the black adhesive layer plays a role as a spacer while enhancing the light shielding property.

In addition, the rigidity (hardness) indicated by the Young's modulus of the black adhesive layer is also an important factor for the vibration, and the higher the rigidity (Young's modulus) is, the easier the vibration is transmitted, so that the black adhesive layer can be appropriately adjusted so as to increase the rigidity by the filler.

Therefore, in the above configuration of the present invention, the black adhesive layer may be formed of a filler-containing black adhesive obtained by mixing a black filler with a black adhesive.

Examples of the black filler include carbon black and graphite.

In addition, the size (diameter) of the black filler is 5 to 20 μm, and the mixing amount (density) with respect to the black adhesive is preferably 0.25 wt %.

With such a configuration, ghost flare can be reduced, and rigidity (Young's modulus) is increased, so that vibration is more easily transmitted from the vibrating body to the first lens.

In addition, in the configuration of the present invention, the black adhesive layer may be provided on a bonding surface to which the vibrating body is bonded in the flat surfaces, and ink may be provided on a surface other than the bonding surface.

With such a configuration, when the black adhesive is more expensive than the ink, cost can be reduced by providing the black adhesive layer only on the bonding surface and providing the ink layer formed by the ink on a surface other than the bonding surface.

Further, the present invention also provides a camera module including the lens unit, an imaging system including the camera module, and a mobile body on which the imaging system is mounted. With such a camera module, an imaging system, and a mobile body, it is possible to obtain operations and effects similar to those of the lens unit described above. Note that the “mobile body” refers to all objects that can move, and examples thereof include vehicles and the like.

### Advantageous Effects of Invention

According to the present invention, vibration is easily transmitted from a vibrating body to a first lens.

### BRIEF DESCRIPTION OF DRAWINGS

FIG. 1 illustrates a first embodiment of the present invention, and is a schematic cross-sectional view of a lens unit.

FIG. 2 is a cross-sectional view of a main part of the lens unit.

FIG. 3 illustrates a second embodiment of the present invention, and is a cross-sectional view illustrating a black adhesive layer and the vicinity thereof.

FIG. 4 illustrates a third embodiment of the present invention, and is a cross-sectional view of a main part.

FIG. 5 is a schematic cross-sectional view of a camera module including the lens unit according to the first embodiment of the present invention.

FIG. 6 is a schematic view of a vehicle as a mobile body on which an imaging system (in-vehicle system) including a camera module according to an embodiment of the present invention is mounted.

FIG. 7 is a block diagram illustrating a configuration of an imaging apparatus constituting the imaging system illustrated in FIG. 6.

FIG. 8 is a schematic cross-sectional view of a conventional lens unit.

### DESCRIPTION OF EMBODIMENTS

Hereinafter, an embodiment of the present invention will be described with reference to the drawings, and the present embodiment contributes to “9.1 Develop quality, reliable, sustainable and resilient infrastructure, including regional and transborder infrastructure, to support economic development and human well-being, with a focus on affordable and equitable access for all” of “9. Build the foundation for industry and technological innovation” of the Sustainable Development Goals (SDGs) proposed by the United Nations.

Note that the lens unit of the present embodiment described below is particularly for a camera module such as an in-vehicle camera, and for example, is fixedly installed on the outer surface side of an automobile, and wiring is drawn into the automobile and connected to a display or other apparatuses.

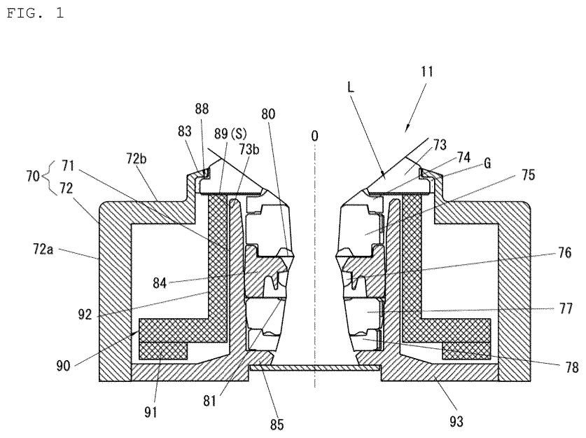

Note that the lens unit of the present embodiment described below is particularly for a camera module such as an in-vehicle camera, and for example, is fixedly installed on the outer surface side of an automobile, and wiring is drawn into the automobile and connected to a display or other apparatuses. Further, in FIGS. 1, 2, 4, and 5, hatching is omitted for the lens.

### First Embodiment

FIG. 1 illustrates a lens unit 11 according to a first embodiment of the present invention. As illustrated in the drawing, the lens unit 11 of the present embodiment includes, for example, a cylindrical lens barrel (barrel) 70 made of resin. The lens barrel 70 includes a lens barrel main body 71 and a cap 72 attached to an end of the lens barrel main body 71 on the object side, and a plurality of (for example, 6) lenses 73, 74, 75, 76, 77, and 78, two diaphragm members 80 and 81, and one annular spacer 84 are provided in the lens barrel 70. An in-vehicle camera including this lens unit 11 includes a lens unit 11, a substrate having an image sensor (not illustrated), and an installation member (not illustrated) for installing the substrate in a vehicle such as an automobile.

Further, the first lens 73 located closest to the object side is a glass lens, and the lenses 74 to 78 are resin lenses, but it is not limited thereto (for example, the lens 73 may be a resin lens).

In addition, an antireflection film, a hydrophilic film, a water-repellent film, and the like are provided on the surface of the lenses 73 to 78 as necessary.

The plurality of lenses 73 to 78 fixed to and supported by the lens barrel 70 is arranged in a state where optical axes of the lenses are matched with each other, and the lenses 73 to 78 are arranged along one optical axis o to constitute one lens group L used for imaging.

Of the two diaphragm members 80 and 81, the first diaphragm member 80, counting from the object side (one end of the lens barrel 70), is disposed between the third lens 75, also counting from the object side, and the spacer 84. The second diaphragm member 81, counting from the object side, is disposed between the spacer 84 and the fifth lens 77, counting from the object side.

The diaphragm members 80 and 81 are “aperture diaphragms” that limit the amount of transmitted light and determine an F value to be an index of brightness, or “light-shielding diaphragms” that shield light beams that cause ghosts and light beams that cause aberrations.

Further, in the present embodiment, the cap 72 is disposed on the radially outside the lens barrel main body 71. The cap 72 includes a cylindrical cap main body 72a, an annular plate-like top plate 72b integrally formed with the cap main body 72a at an upper end of the cap main body 72a, and a caulking portion 83 integrally formed with the top plate 72b at an inner diameter edge of the top plate 72b.

A length of the cap 72 in an optical axis direction is substantially equal to a length of the lens barrel main body 71 in the optical axis direction, and the caulking portion 83 protrudes upward from an end (upper end in FIG. 1) of the lens barrel main body 71 on the object side.

In addition, the caulking portion 83 of the end on the object side (the upper end in FIG. 1) is thermally caulked radially inward in a state where the lens group L is incorporated and accommodated and held in the inner accommodating space of the lens barrel 70, whereby the first lens 73 located closest to the object side of the lens group L is fixed in the optical axis direction to an object side end of the lens barrel 70 (object side end of the cap 72) by the caulking portion 83.

Further, an inner flange 85 having an aperture having a diameter smaller than that of the sixth lens 78 is provided at an end (lower end in FIG. 1) of the lens barrel main body 71 on the image side. The plurality of lenses 73 to 78 constituting the lens group L, the diaphragm members 80 and 81, and the spacer 84 are held and fixed in the optical axis direction in the lens barrel 70 by the inner flange 85 and the caulking portion 83.

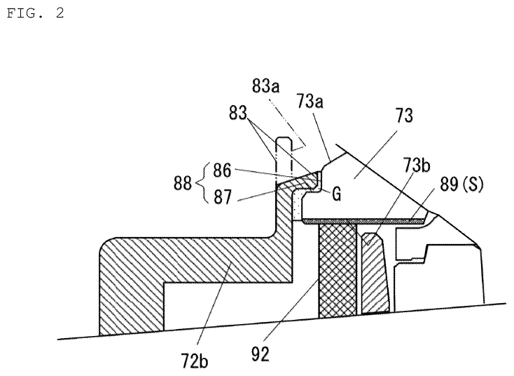

Further, in the present embodiment, as illustrated in FIGS. 1 and 2, a step 88 including a cylindrical surface 86 parallel to the optical axis O and an annular surface 87 orthogonal to the optical axis O is provided on an outer peripheral portion of a surface (lens surface) 73a of the first lens 73 facing the object side. The cylindrical surface 86 is formed coaxially with the optical axis O, an upper end (upper end in the optical axis direction) of the cylindrical surface 86 reaches the lens surface 73a of the first lens 73, and a lower end (lower end in the optical axis direction) of the cylindrical surface 86 is smoothly connected to an inner diameter end of the annular surface 87 by an arc surface. The annular surface 87 is formed coaxially with the optical axis O, and its outer diameter end reaches an outer peripheral surface of the first lens 73. Note that an outer peripheral portion of the annular surface 87 is a chamfered portion, and an outer diameter end of the chamfered portion reaches the outer peripheral surface of the first lens 73.

The step 88 having such a cylindrical surface 86 and an annular surface 87 is formed in a substantially L-shaped cross section on the outer peripheral portion of the surface (lens surface) 73a of the first lens 73 facing the object side, and has an upper side opened to the lens surface 73a of the first lens 73 and a side opened to the outer peripheral surface (outer peripheral side surface) of the first lens 73.

The caulking portion 83 is formed at an opening edge portion provided at a radially central portion of the top plate 72b of the cap 72. The caulking portion 83 before caulking stands in the optical axis direction, and an inner side surface 83a facing the radial inside is directed parallel to the optical axis O. An outer peripheral surface on a lower side (lower side in the optical axis direction) of the annular surface 87 of the step 88 of the first lens 73 is close to a lower end (lower end in the optical axis direction) of the inner side surface 83a, the inner side surface 83a on an upper side (upper side in the optical axis direction) of the annular surface 87 is disposed in parallel with and spaced apart from the cylindrical surface 86, and an upper end thereof protrudes upward from an outer peripheral edge of the lens surface 73a of the first lens 73.

Therefore, the side (radial side) of the step 88 is closed by an outer peripheral surface of the caulking portion 83 on the upper side (upper side in the optical axis direction) of the annular surface 87, and thus, the closed step 88 is filled with an adhesive G before caulking the caulking portion 83. The filling amount of the adhesive G is set to such an amount that the adhesive G does not overflow from the step 88 and cover the outer peripheral edge of the lens surface 73a of the first lens 73 when the caulking portion 83 is caulked. Note that, before caulking the caulking portion 83, the adhesive G with which the step 88 is filled is also filled in a gap below the step 88 (gap between a rising portion of the caulking portion 83 and the outer peripheral surface of the first lens 73).

Then, after the step 88 is filled with the adhesive G, the caulking portion 83 is thermally caulked radially inward so as to cover the surface of the adhesive G, thereby fixing the first lens 73 to the object side end of the lens barrel 70 (object side end of the cap 72) in the optical axis direction. At this time, since the step 88 is closed by the upper end of the caulking portion 83 being caulked radially inward and bent, the adhesive G filled in the step 88 is brought into close contact with the inner side surface 83a of the caulking portion 83 including the bent portion and the cylindrical surface 86 and the annular surface 87 of the step 88, and is cured to bond the first lens 73 to the cap 72 of the lens barrel 70 without any gap. In this manner, the step 88 of the first lens 73 is held by the caulking portion 83 of the cap 72, and the first lens 73 and the subsequent lens 74 to 78 are fixed in the optical axis direction.

Further, in the present embodiment, as illustrated in FIG. 2, a black adhesive layer 89 is provided on a flat surface 73b of the first lens 73 facing the image side, and a vibrating body 92 to be described later is bonded to the flat surface 73b via the black adhesive layer 89. As a black adhesive S forming the black adhesive layer 89, an epoxy-based adhesive is used.

Further, the Young's modulus of the black adhesive layer 89 is 2 to 5 GPa, and the layer thickness of the black adhesive layer 89 is 5 to 20 μm. The black adhesive layer 89 is formed in substantially the same shape as the flat surface 73b of the first lens 73, and is disposed coaxially with the optical axis O.

Conventionally, ink applied to the flat surface 73b of the first lens 73 contains a resin coating material as a main component, and has a Young's modulus substantially equal to that of the black adhesive layer 89. When the resin coating material as the main component of ink is an epoxy-based coating material, the Young's modulus of ink is 2 to 5 GPa as with the black adhesive layer 89. As described above, the black adhesive layer 89 is provided on the flat surface 73b facing the image side of the first lens 73 located closest to the object side, and an upper end surface of the vibrating body 92 is bonded to the flat surface 73b by the black adhesive layer 89.

Further, in the present embodiment, as illustrated in FIG. 1, a vibration mechanism 90 that vibrates the first lens 73 is provided.

The vibration mechanism 90 includes a vibrator 91 that performs ultrasonic vibration, and a vibrating body 92 that transmits the ultrasonic vibration of the vibrator 91 to the first lens 73. The vibrator 91 is formed in an annular plate shape and is provided inside the cap main body 72a of the cap 73. The vibrator 91 is formed of, for example, a piezoelectric device.

Further, a bottom plate 93 is provided integrally with the lens barrel main body 71 at an end on the image side (lower end in FIG. 1) of the lens barrel main body 71, the bottom plate 93 is formed in an annular plate shape coaxially with the optical axis O, and an outer peripheral surface thereof is fixed to a lower end inner peripheral surface of the lens barrel main body 71. The vibrator 91 is provided coaxially with the optical axis O on an upper surface of the bottom plate 93, and the vibrating body 92 is fixed to an upper surface of the vibrator 91. The vibrating body 92 is formed in a cylindrical shape coaxial with the optical axis O, and the flat surface 73b facing the image side of the first lens 73 is bonded to the upper end surface (end surface on the object side) of the vibrating body via a black adhesive layer 89 formed of the black adhesive S.

In such a vibration mechanism 90, when the vibrator 91 ultrasonically vibrates, the vibrating body 92 ultrasonically vibrates, and the first lens 73 ultrasonically vibrates via the vibrating body 92, whereby foreign matter such as water droplets, muddy water, ice and snow, and frost adhering to the lens surface 73a of the first lens 73 is removed.

As described above, according to the present embodiment, since the black adhesive layer 89 is provided on the flat surface 73b facing the image side of the first lens 73, and the vibrating body 92 is bonded to the flat surface 73b via the black adhesive layer 89, the ink layer is not interposed between the vibrating body 92 and the flat surface of the first lens 73, and only the black adhesive layer 89 is interposed, so that vibration is easily transmitted from the vibrating body 92 to the first lens 73.

Further, by ultrasonically vibrating the first lens 73 by the vibrating body 92 of the vibration mechanism, foreign matter such as water droplets, muddy water, ice and snow, and frost adhering to the lens surface of the first lens 73 can be removed.

In addition, since the step 88 including the cylindrical surface 86 and the annular surface 87 is provided on the outer peripheral portion of the surface (lens surface) 73a of the first lens 73 facing the object side, and the step 88 is filled with the adhesive G, the first lens 73 can be adhered to the cap 72 of the lens barrel 70 without any gap by the adhesive G. Then, since the caulking portion 83 covers the adhesive G and fixes the first lens 83 to the lens barrel 70 by caulking, the adhesive G is protected by the caulking portion 83 without being exposed to the outside, and furthermore, the first lens 73 is firmly fixed to the lens barrel 70 by the caulking portion 83.

Therefore, entry of moisture and dust from between the first lens 73 and the lens barrel 70 can be prevented without using an O-ring.

Further, since the O-ring is not used, it is possible to prevent deterioration of optical performance due to deviation of the first lens 73 in the optical axis direction by receiving a reaction force from the O-ring.

Furthermore, since the O-ring is not used, the number of components does not increase accordingly, and there is no trouble in mounting the O-ring.

In addition, since the O-ring is not used, ultrasonic vibration is not absorbed by the O-ring, and the first lens 73 can be reliably ultrasonically vibrated.

### Second Embodiment

FIG. 3 illustrates a second embodiment, and is a cross-sectional view illustrating the black adhesive layer 89 and the vicinity thereof.

The present embodiment is different from the first embodiment in that a black filler is mixed and dispersed in the black adhesive layer 89, and other configurations are similar to those of the first embodiment, and thus illustration and description of the configurations are omitted as in the first embodiment.

In the first embodiment, the layer thickness of the black adhesive layer 89 formed by the black adhesive S is about 5 to 20 μm, but in this case, the black adhesive layer 89 cannot sufficiently shield light and transmits the light, and there is a possibility that ghost flare cannot be reduced. Therefore, by mixing a black filler 95 with the black adhesive S, the black adhesive layer 89 also becomes uniform and thickness unevenness is less likely to occur because the black adhesive layer plays a role as a spacer while enhancing the light shielding property.

In addition, the rigidity (hardness) indicated by the Young's modulus of the black adhesive layer 89 is also an important factor for the ultrasonic vibration, and the higher the rigidity (Young's modulus), the easier the vibration is transmitted, so that the black adhesive layer 89 can be appropriately adjusted so as to increase the rigidity by the filler 95.

Therefore, in the present embodiment, the black adhesive layer 89 is formed of a filler-containing black adhesive obtained by mixing the black filler 95 with the black adhesive S.

Examples of the black filler 95 include carbon black and graphite, and a large number of black fillers 95 are uniformly dispersed in the black adhesive layer 89.

The size (diameter) of the black filler 95 is 5 to 20 μm, and the mixing amount (density) with respect to the black adhesive S is about 0.25 wt %.

According to the present embodiment, effects similar to those of the first embodiment can be obtained, and since the black adhesive layer 89 is formed of a filler-containing black adhesive obtained by mixing the black filler 95 with the black adhesive S, ghost flare can be reduced, and rigidity (Young's modulus) is increased, so that ultrasonic vibration is more easily transmitted from the vibrating body 92 to the first lens 73.

### Third Embodiment

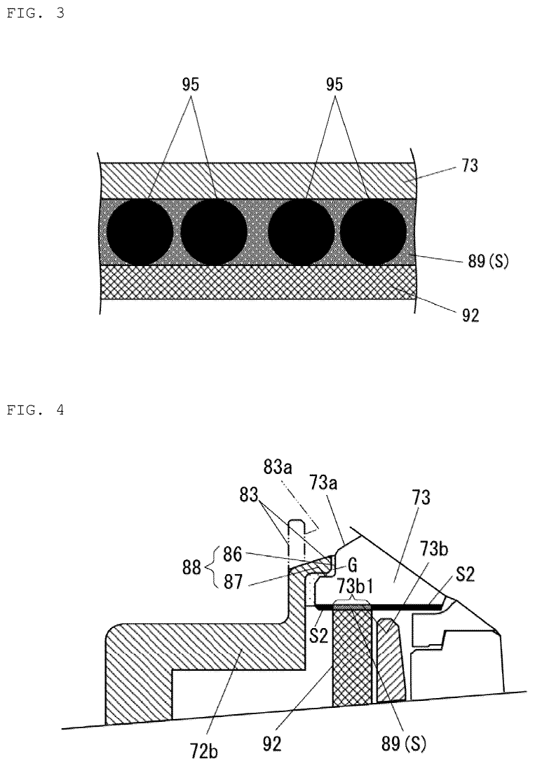

FIG. 4 illustrates a third embodiment, and is a cross-sectional view of a main part.

The present embodiment is different from the first and second embodiments in a range in which the black adhesive layer 89 is provided, and thus this point will be described below, and description of other common configurations will be omitted. Note that, in FIG. 4, components common to those illustrated in FIG. 3 are denoted by the same reference numerals.

As illustrated in FIG. 4, in the present embodiment, the black adhesive layer 89 is provided on a bonding surface 73b1 to which the upper end surface of the vibrating body 92 is bonded among the flat surfaces 73b of the first lens 73, and the ink S2 is provided on a surface other than the bonding surface 73b1.

That is, since the vibrating body 92 is formed in a cylindrical shape, an upper end surface (end surface on the object side) thereof is formed in an annular shape. A surface to which the annular surface of the annular shape is bonded is a bonding surface 73b1, and the bonding surface 73b1 is also an annular surface. The black adhesive layer 89 is provided on the bonding surface 73b1, and the upper end surface of the vibrating body 92 is bonded to the bonding surface 73b1 by the black adhesive layer 89. The black adhesive layer may be formed of the black adhesive S as in the first embodiment, or may be formed of a filler-containing black adhesive obtained by mixing the black filler 95 with the black adhesive S as in the second embodiment.

According to the present embodiment, effects similar to those of the first and second embodiments can be obtained, and when the black adhesive S is more expensive than ink, cost can be reduced by providing the black adhesive layer 89 only on the bonding surface 73b1 and providing the ink S2 on a surface other than the bonding surface 73b1.

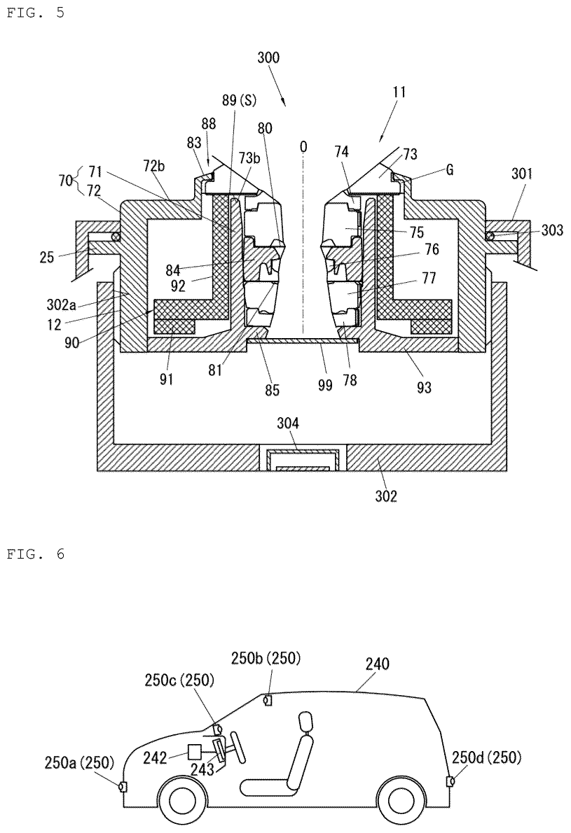

FIG. 5 is a schematic cross-sectional view of a camera module 300 of the present embodiment including the lens unit 11 illustrated in FIG. 1. As illustrated in the drawing, the camera module 300 includes a lens unit 11 to which a filter 99 is attached. Note that the lens unit 11 may be the lens unit 11 described in the second or third embodiment.

The camera module 300 includes an upper case (camera case) 301 that is an exterior component, and a mount (base) 302 that holds the lens unit 11. Further, the camera module 300 includes a sealing material 303 and a package sensor (image sensor) 304.

The upper case 301 is a member that is engaged with an outer flange 25 provided in a flange shape on an outer peripheral surface of the lens barrel 70 and exposes an end of the lens unit 11 on the object side to cover the other portion. The mount 302 is disposed inside the upper case 301 and has a female screw 302a screwed with a male screw 12 of the lens unit 11. The sealing material 303 is a member interposed between an inner surface of the upper case 301 and the outer peripheral surface of the lens barrel 70 of the lens unit 11, and is a member for maintaining airtightness inside the upper case 301.

The package sensor 304 is disposed inside the mount 302 so as to face the infrared cut filter 99, and is disposed at a position where an image of an object formed by the lens unit 11 is received. Further, the package sensor 304 includes a CCD, a CMOS, or the like, and converts light condensed and arriving through the lens unit 11 into an electrical signal. The converted electrical signal is converted into analog data or digital data which is a component of image data captured by the camera.

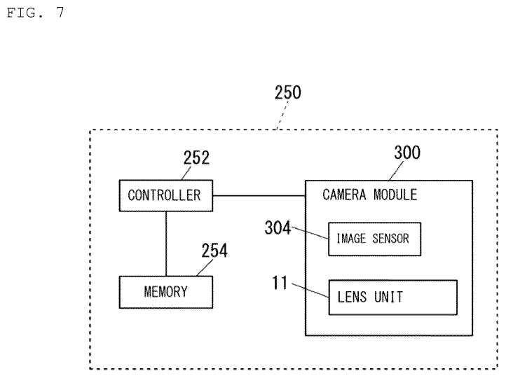

FIG. 6 schematically illustrates a vehicle 240 as a mobile body on which an in-vehicle system (imaging system) including the imaging apparatus 250 including the camera module 300 illustrated in FIG. 5 is mounted. As illustrated, the imaging apparatus 250 can be mounted on the vehicle 240, and FIG. 6 is an arrangement example illustrating a mounting position of the imaging apparatus 250 in the vehicle 240. The imaging apparatus 250 mounted on the vehicle 240 can also be referred to as an in-vehicle camera, and can be installed at various places of the vehicle 240. For example, a first imaging apparatus 250a may be disposed at or near a front bumper as a camera for monitoring the front when vehicle 240 travels. In addition, a second imaging apparatus 250b that monitors the front may be disposed near an inner rearview mirror in the cabin of vehicle 240. The third imaging apparatus 250c may be disposed on a dashboard, in an instrument panel, or the like as a camera for monitoring the driving situation of the driver. The fourth imaging apparatus 250d may be installed at the rear of the vehicle 240 for rear monitoring of the vehicle 240. The imaging apparatuses 250a and 250b can be referred to as front cameras. The third imaging apparatus 250c can be referred to as an in-camera. The fourth imaging apparatus 250d can be referred to as a rear camera. The imaging apparatus 250 is not limited thereto, and includes imaging apparatuses installed at various positions such as a left side camera that images a left rear side and a right side camera that images a right rear side.

An image signal of an image captured by the imaging apparatus 250 can be output to an information processing apparatus 242 and/or a display apparatus 243 in the vehicle 240. The information processing apparatus 242 and the display apparatus 243 constitute an in-vehicle system together with the imaging apparatus 250. The information processing apparatus 242 in the vehicle 240 includes a apparatus that processes the image signal acquired by the imaging apparatus 250, recognizes the image, and assists the driver in driving. Further, the information processing apparatus 242 includes, for example, a navigation apparatus, a collision damage reduction brake apparatus, an inter-vehicle distance control apparatus, a lane departure warning apparatus, and the like, but is not limited thereto. The display apparatus 243 displays an image processed and output by the information processing apparatus 242, but can also directly receive the image signal from the imaging apparatus 250. In addition, the display apparatus 243 may employ a liquid crystal display (LCD), an organic electro-luminescence (EL) display, and an inorganic EL display, but is not limited thereto. The display apparatus 243 can display, to the driver, the image signal output from the imaging apparatus 250 that captures an image of a position difficult to be visually recognized by the driver, such as the rear camera (can output information for the occupant).

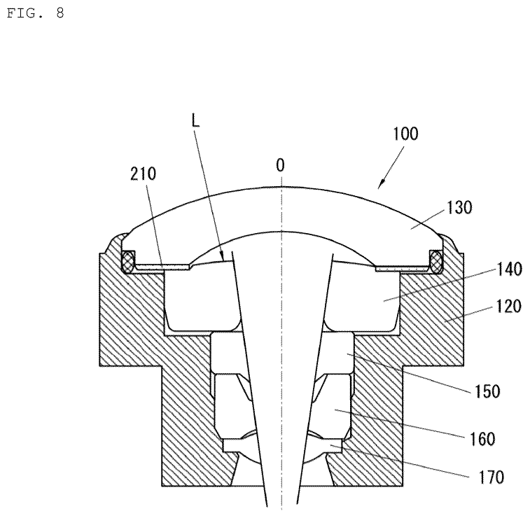

FIG. 7 illustrates a configuration of an imaging apparatus included in the in-vehicle system illustrated in FIG. 6. As illustrated, the imaging apparatus 250 according to the embodiment includes a controller 252, a memory 254, and the camera module 300 illustrated in FIG. 6 described above.

The controller 252 controls the camera module 300 and processes an electrical signal output from the image sensor 304 of the camera module 300. The controller 252 may be configured as, for example, a processor. Further, the controller 252 may include one or more processors. The processor may include a general-purpose processor that loads a specific program and executes a specific function, and a dedicated processor specialized for specific processing. The dedicated processor may include an application-specific integrated circuit (IC). The application-specific IC is also referred to as an application specific integrated circuit (ASIC). The processor may include a programmable logic device. The programmable logic device is also referred to as a programmable logic device (PLD). The PLD may include a field-programmable gate array (FPGA). The controller 252 may be either a system-on-a-chip (SoC) in which one or more processors cooperate or a system in a package (SiP).

The memory 254 stores various types of information or parameters related to the operation of the imaging apparatus 250. The memory 254 may include, for example, a semiconductor memory or the like. The memory 254 may function as a work memory of the controller 252. The memory 254 may store a captured image. The memory 254 may store various parameters and the like for the controller 252 to perform detection processing based on the captured image. The memory 254 may be included in the controller 252.

As described above, the camera module 300 captures a subject image formed via the lens unit 11 by the image sensor 304, and outputs the captured image. The image captured by the camera module 300 is also referred to as a captured image.

The image sensor 304 may be constituted by, for example, a complementary metal oxide semiconductor (CMOS) image sensor, a charge coupled device (CCD), or the like. The image sensor 304 has an imaging surface on which a plurality of pixels is arranged. Each pixel outputs a signal specified by a current or a voltage according to the amount of incident light. The signal output from each pixel is also referred to as imaging data.

The imaging data may be read out by the camera module 300 for all the pixels and taken into the controller 252 as a captured image. The captured image read for all the pixels is also referred to as a maximum captured image. The imaging data may be read by the camera module 300 for some pixels and captured as a captured image. In other words, the imaging data may be read from pixels in a predetermined capturing range. The imaging data read from the pixels in the predetermined capturing range may be captured as a captured image. The predetermined capturing range may be set by the controller 252. The camera module 300 may acquire a predetermined capturing range from the controller 252. The image sensor 304 may capture an image in a predetermined capturing range of the subject image formed via the lens unit 11.

Note that the present invention is not limited to the embodiments described above, and various modifications can be made without departing from the gist thereof. For example, in the present invention, the shape and the like of the lens, the lens barrel, and the like are not limited to the embodiments described above. In addition, a part or all of the embodiments described above may be combined, or a part of the configuration may be omitted from one of the above-described embodiments without departing from the gist of the present invention.

### REFERENCE SIGNS LIST

11 Lens unit
70 Lens barrel
73 First lens
73b Flat surface
73b1 Bonding surface
74 to 78 Lens
71 Lens barrel main body
89 Black adhesive layer
90 Vibration mechanism
92 Vibrating body
95 Black filler
240 Vehicle (mobile body)
242 Processing apparatus
243 Display apparatus
250 Imaging apparatus
252 Controller
300 Camera module
304 Image sensor
L Lens group
O Optical axis
S Black adhesive

1. A lens unit comprising a lens group in which a plurality of lenses is arranged along an optical axis of the lenses, and a lens barrel that houses and holds the lens group, wherein
the lens unit comprises a vibration mechanism including a vibrating body that vibrates a first lens located closest to an object side among the plurality of lenses,
a black adhesive layer is provided on a flat surface of the first lens facing an image side, and
the vibrating body is bonded to the flat surface via the black adhesive layer.

2. The lens unit according to claim 1, wherein the black adhesive layer is formed of a filler-containing black adhesive obtained by mixing a black filler with a black adhesive.

3. The lens unit according to claim 1, wherein the black adhesive layer is provided on a bonding surface to which the vibrating body is bonded in the flat surface, and
ink is provided on a surface other than the bonding surface.

4. The lens unit according to claim 2, wherein the black adhesive layer is provided on a bonding surface to which the vibrating body is bonded in the flat surface, and
ink is provided on a surface other than the bonding surface.

5. A camera module comprising: the lens unit according to claim 1; and an image sensor that converts light condensed through the lens group of the lens unit into an electrical signal.

6. An imaging system comprising:
an imaging apparatus including the camera module according to claim 5 and a controller that controls the camera module and processes an electrical signal output from an image sensor of the camera module;
a processing apparatus that processes an image signal acquired by the imaging apparatus; and
a display apparatus that displays an image processed and output by the processing apparatus.

7. A mobile body comprising the imaging system according to claim 6, wherein the display apparatus outputs information for an occupant.
